(19) United States
(12) Patent Application Publication
(10) Pub. No.: US 2018/0127055 A1
(43) Pub. Date: May 10, 2018

(54) ELECTRIC MOTORCYCLE AND RELEVANT WIRING

(71) Applicant: VISIONAR S.R.L., Montefano (MC) (IT)

(72) Inventors: Antonio RANALLI, Montefano (MC) (IT); Andrea ANDREUCCI, Osimo (AN) (IT)

(21) Appl. No.: 15/800,626

(22) Filed: Nov. 1, 2017

(30) Foreign Application Priority Data
Nov. 8, 2016 (IT) 102016000112598

(51) Int. Cl. B62M 7/10; B60K 1/04; B60K 6/485; B60K 7/00; B60K 17/356; B62K 25/08

(52) U.S. Cl. CPC B62M 7/10; B60K 1/04; B60K 6/485; B60K 7/0007; B62K 2204/00; B62K 25/08; B60Y 2200/12; B60K 2001/0411; B60K 17/356

(57) ABSTRACT

An electric motorcycle includes an electric motor disposed in a hub assembly of a wheel of the motorcycle; a plurality of internal cables connected to the electric motor, a first connector assembly disposed in the hub assembly and connecting the internal cables to a plurality of external cables, a second connector assembly disposed on the suspension and connecting the external cables to a plurality of upper cables, a plurality of rigid tubes inside which said upper tubes are disposed in such a way that the upper cables come out of the rigid tubes in correspondence of an upper part of the suspension, support and guide means connected to the suspension and suitable for supporting and guiding the rigid tubes, and an electric power system and a control unit disposed in the motorcycle and connected to the upper cables coming out of the rigid tubes.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### INCORPORATION-BY-REFERENCE OF MATERIALS SUBMITTED ON A COMPACT DISC

Not applicable.

### BACKGROUND OF THE INVENTION

### 1. Field of the Invention

The present patent application for invention relates to an electric motorcycle, and in particular to the wiring of an electrical motor used for driving motor vehicles and housed inside the wheel.

### 2. Description of Related Art Including Information Disclosed Under 37 CFR 1.97 and 37 CFR 1.98

Electric motors are used both in hybrid motorcycles (where one or more internal combustion motors are assisted by one or more electric motors) and in completely electric motorcycles.

Generally speaking, the electric motor is disposed in the front wheel of the motorcycle in order to implement a four-wheel drive in a simpler way compared to other systems. A wiring must electrically connect the electric motor to the power supply system and to a control unit. Such a wiring comprises power cables for connection to the power supply system and signal cables for connection to the control unit.

The front wheel is connected to the frame of the motorcycle by means of suspensions that are used to insulate the frame from the road. The travel of said suspensions may range from 100 mm to 300 mm according to whether the motorcycle is a road or an off-road motorcycle. During the motion of the front wheel, the wiring must be guided, otherwise it may interfere with other elements of the motorcycle, such as for example wheel or plastic parts, or with external elements, such as for example branches and trees, especially in the case of off-road motorcycles.

When the wheel that contains the electric motor is to be taken down for tire replacement or maintenance operations, the wiring of the electric motor needs to be disconnected and protected in order not to be damaged.

Moreover, the wiring of the electric motor must be protected against external agents, such as for example stones, branches, etc. especially during off-road use.

GB2265588 discloses a hybrid motorcycle with electric drive on both wheels.

US20100089671 discloses a hybrid motorcycle comprising a geared motor housed inside the front wheel.

However, neither GB2265588 nor US20100089671 disclose the mechanical configuration of the wiring of the electric motors in detail.

JP2013006528 discloses an electric motorcycle comprising a motor housed in a front wheel.

The purpose of the present invention is to eliminate the drawbacks of the prior art by disclosing an electric motor provided with a wiring system of the motor that is reliable, versatile, simple, practical and suitable for being also used in off-road motorcycles with a large travel of the suspension assembly.

### BRIEF SUMMARY OF THE INVENTION

These purposes are achieved according to the invention with the characteristics of the independent claim 1.

Advantageous embodiments of the invention appear from the dependent claims.

The electric motor according to the invention comprises:
an electric motor disposed in a hub assembly of a wheel of the motorcycle,
a suspension that supports a shaft of the hub assembly,
a plurality of internal cables connected to the electric motor,
a first connector assembly disposed in the hub assembly and connecting the internal cables to a plurality of external cables,
a second connector assembly disposed on the suspension and connecting the external cables to a plurality of upper cables,
a plurality of rigid tubes inside which said upper tubes are disposed, in such a way that the upper cables come out of the rigid tubes in correspondence of an upper part of the suspension,
support and guide means connected to the suspension and intended to support and guide said rigid tubes, and an electric power system and a control unit disposed in said motorcycle and connected to said upper cables that come out of the rigid tubes.

The main advantage of the electric motorcycle according to the invention is the functionality and reliability of the wheel and electric motor assembly compared to the prior art and to the traditional construction technology.

The wiring of the motorcycle according to the invention can be applied both to off-road and road motorcycles; the major advantages are obtained in off-road motorcycles because the travels of the suspension of the wheel wherein an electric motor is disposed are larger and the invention provides for a more reliable wiring of the electric motor.

### BRIEF DESCRIPTION OF THE SEVERAL VIEWS OF THE DRAWINGS

Additional features of the invention will appear manifest from the detailed description below, which refers to merely illustrative, not limiting embodiments.

FIG. 1 is a partially interrupted perspective view of the electric motorcycle according to the invention.

FIG. 2 is a perspective view of the electric motor and of a first connector assembly disposed in the hub assembly of the front wheel of the motorcycle of FIG. 1.

FIG. 3 is a perspective view like FIG. 1, which shows the lower portion of the front suspension, wherein a protection is omitted to show a second connector assembly.

FIG. 4 is a side view of the suspension of the motorcycle according to the invention, wherein the protection and the guide are shown in a sectional view.

FIG. 5 is an exploded view of a telescopic arm of the front suspension, the protection and a connection cable.

FIG. 6 is an axial section of a bushing fixed to the shaft of the hub assembly and crossed by the wiring cables.

FIG. 7 is a perspective view of the hub assembly and an exploded view of a casing of the hub assembly.

FIG. 8 is a perspective exploded view of a second embodiment of the first connector assembly.

FIG. 9 is an axial sectional view of the second embodiment of the first connector assembly.

### DETAILED DESCRIPTION OF THE INVENTION

With reference to the Figures, the motorcycle of the invention is described, which is generally indicated with reference numeral 100.

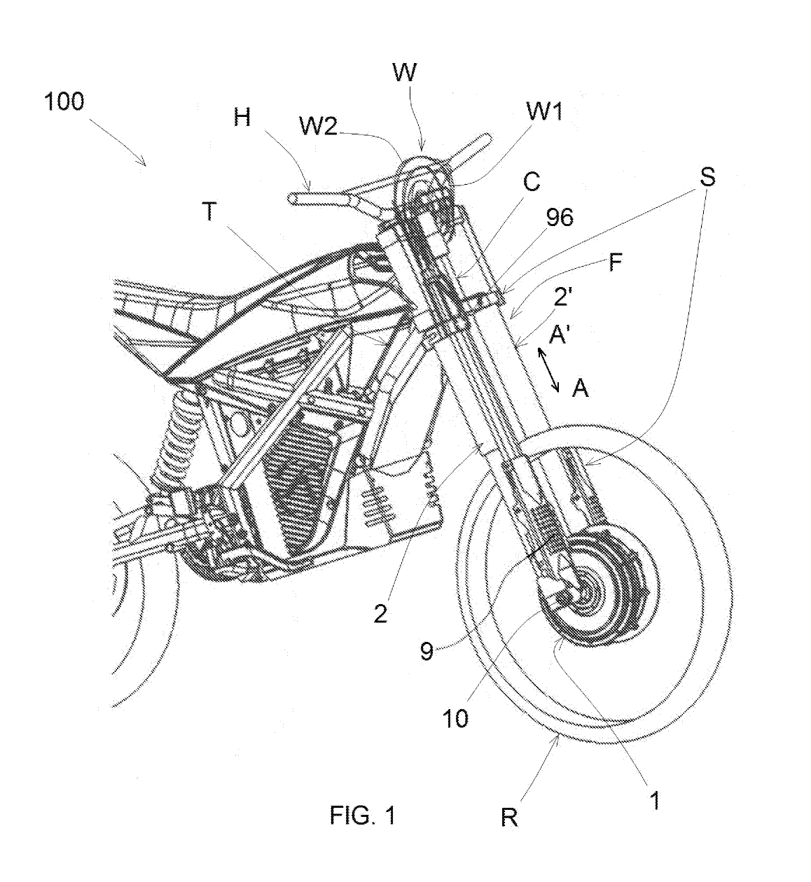

FIG. 1 shows the motorcycle (100) comprising a wheel (R) with a hub assembly (1). The hub assembly (1) comprises a shaft (10) connected in lower position to a suspension (F).

For illustrative purposes, the wheel (R) is a front wheel. In such a case, the suspension (F) is the front suspension, of steering type, revolvingly connected to a frame (T) of the motorcycle. A handlebar (H) is connected in upper position to the suspension (F). For example, the suspension (F) can be of fork type comprising two telescopic arms (2, 2′) provided with internal shock absorber, in such a way to allow for travels in the direction of the arrows A-A′. The suspension (F) can comprise only one telescopic arm.

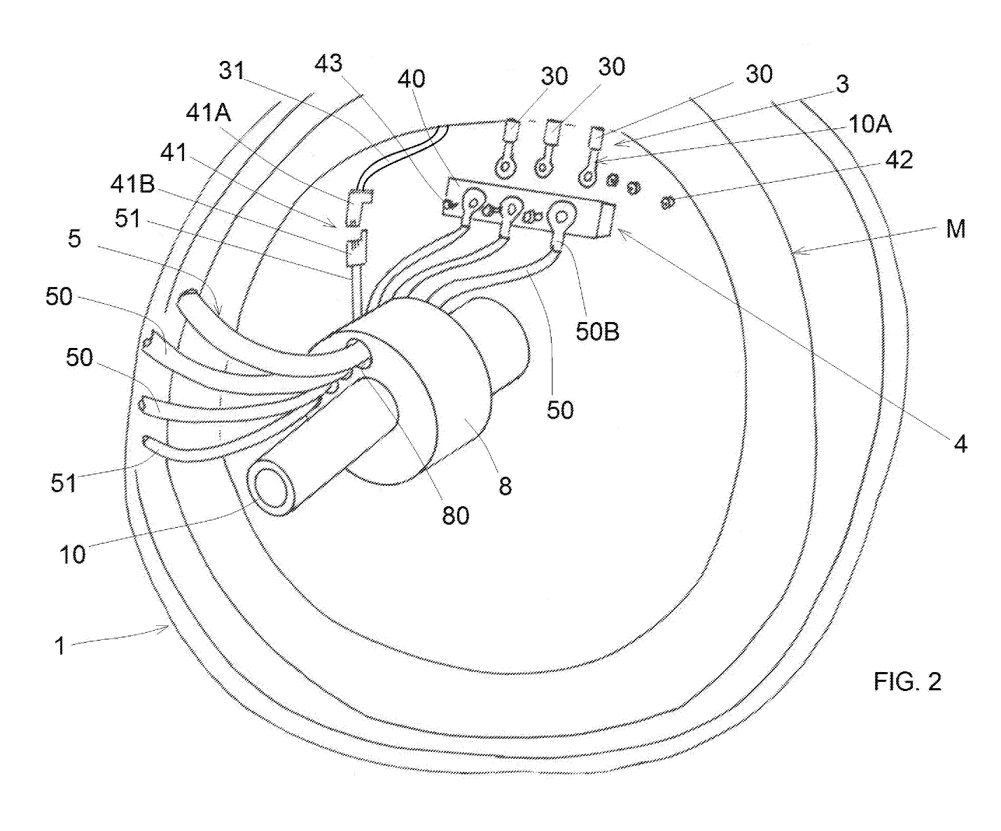

With reference to FIG. 2, an electric motor (M) is disposed inside the hub assembly (1). Although in the figures the motor (M) is disposed in the hub assembly of the front wheel supported by the front suspension, the electric motor (M) can be disposed in the hub assembly of the front wheel supported by the rear suspension that is of non-steering type.

A plurality of internal cables (3) is connected to the electric motor (M). A first connector assembly (4) is disposed in the hub assembly (1) and connects the internal cables (3) to a plurality of external cables (5) that are brought out of the hub assembly (1).

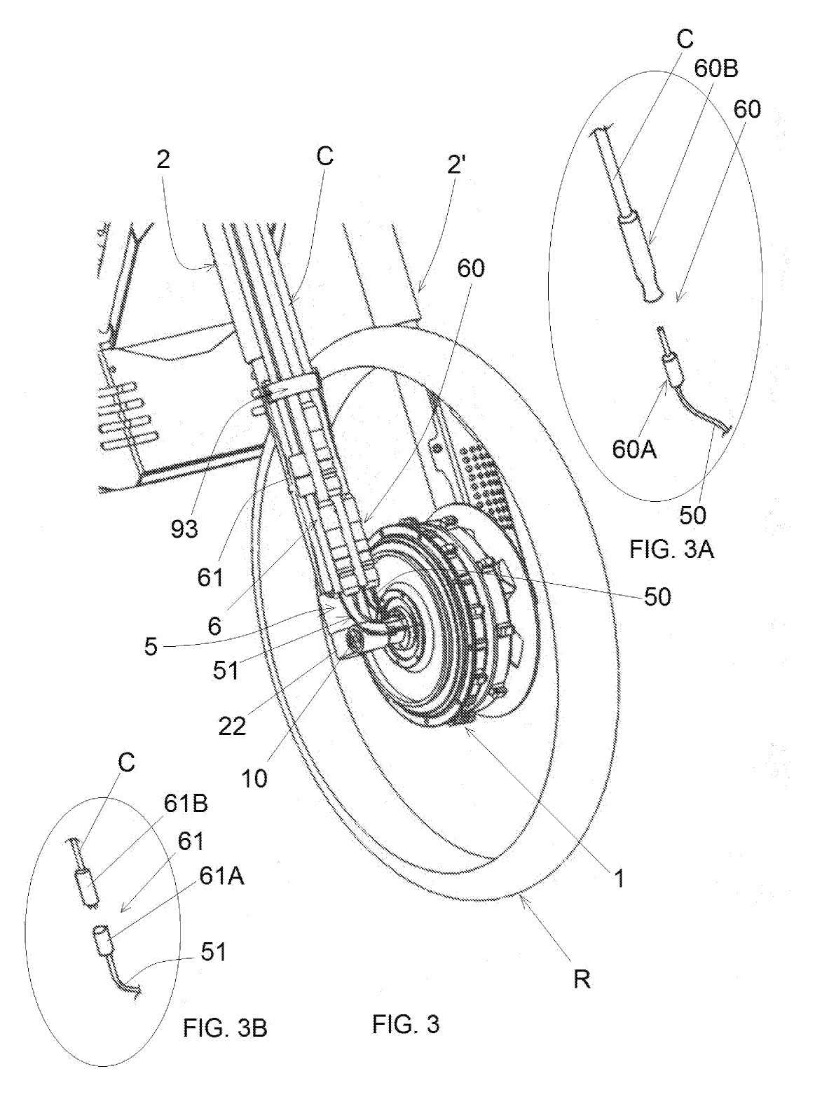

With reference to FIG. 3, a second connector assembly (6) is 30 supported by a telescopic arm (2) of the suspension. The second connector assembly (6) connects the external cables (5) with a plurality of upper cables (W) (see FIG. 1) disposed in rigid tubes (C) supported by the telescopic arm (2) of the suspension.

With reference to FIG. 1, the upper cables (W) come out of the rigid tubes (C) in upper position and are inserted in an upper part of the suspension (F) to connect to a power supply system and to a control unit disposed in the motorcycle to power and control the electric motor (M). Support and guide means (S) are mounted on the suspension (F) and support and guide the rigid tubes (C) along the suspension. The support and guide means (S) comprise a protection (9) disposed in a lower part of the suspension (F) and a guide (96) disposed in an upper part of the suspension (F).

With reference to FIG. 2, for illustrative purposes, the internal cables (3) comprise three unipolar power cables (30) with only one wire and one multipolar signal cable (31) with more wires. Likewise, the external cables (5) comprise three unipolar power cables (50) and one multipolar signal cable (51). With reference to FIG. 1, the upper cables (W) comprise three unipolar power cables (W1) and one multipolar signal cable (W2).

With reference to FIG. 2, the first connector assembly (4) comprises a power connector (40) that connects the power cables (30) and a signal connector (41) that connects the signal cables (31, 51).

The power connector (40) is an electrical terminal board. In such a case, rings contacts (10A, 50A) are disposed at the ends of the power cables (30) of the internal cable assembly and at the ends of the power cables (50) of the external cable assembly. The ring contacts (10A, 50B) of the power cables of the internal cable assembly and of the external cable assembly are inserted in the power connector (40) and fixed by means of screws (43) and nuts (42).

The signal connector (41) comprises a first element (41A) connected at the end of the signal cable (31) of the internal cables and a second element (41B) connected at the end of the signal cable (51) of the external cables. The first element (41A) and the second element (41B) of the signal connector can be the male and female elements of an RJ connector with a number of poles equal to the number of poles of the signal cables.

With reference to FIG. 3, the second connector assembly (6) comprises three power connectors (60) and one signal connector (61). The power connectors (60) connect the power cables (50) of the external cables with the power cables (W1) of the upper cables (W). The signal connector (61) connects the signal cable (31) of the external cables with the signal cable (W2) of the upper cables (W).

With reference to FIG. 3A, each power connector (60) comprises a first element (60A) connected at the end of the power cable (50) of the external cables and a second element (60B) connected at the end of the power cable (51) of the upper cables. The rigid tube (C) is connected to the second element of the connector (60B) in such a way to contain the power cable (W1). The first element (60A) and the second element (60B) of the power connector can be the male and female elements of a jack connector.

With reference to FIG. 3B, the signal connector (61) comprises a first element (61A) connected at the end of the signal cable (51) of the external cables and a second element (61B) connected at the end of the signal cable (51) of the upper cables. The rigid tube (C) is connected to the second element of the connector (61B) in such a way to contain the signal cable (W2). The first element (61A) and the second element (61B) of the signal connector can be the male and female elements of a DIN connector with a number of poles equal to the number of poles of the signal cables.

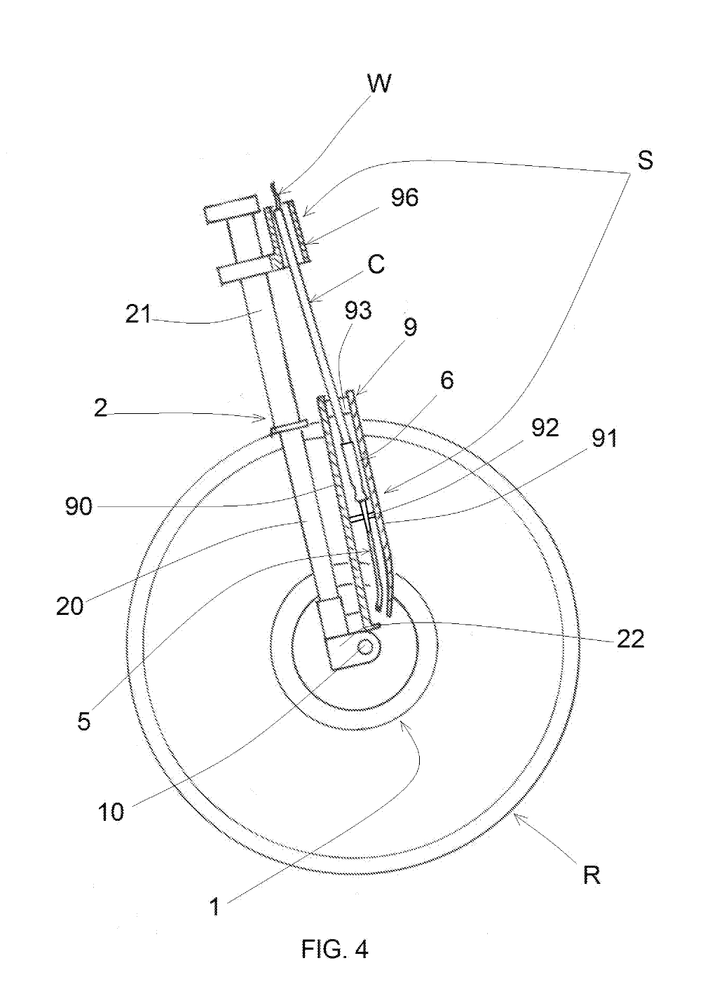

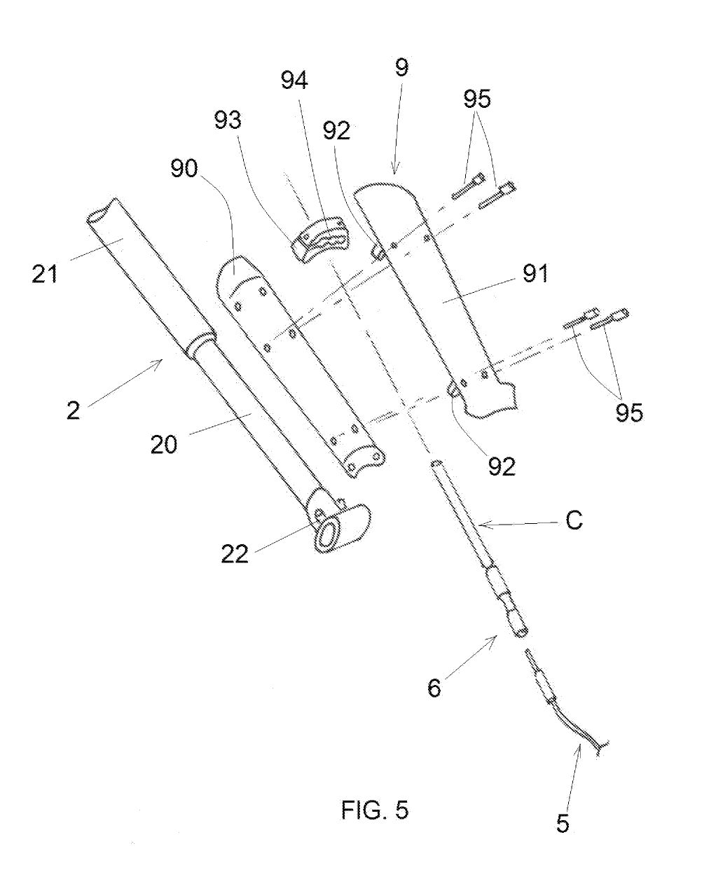

With reference to FIGS. 4 and 5, the telescopic arm (2) of the suspension comprises an internal tube (20) that is slidingly mounted inside an external tube (21). The internal tube (20) has a foot (22) mounted at the lower end of the internal tube. The foot (22) is provided with a sleeve to receive the shaft (10) of the hub assembly.

The protection (9) is mounted on the arm (2) of the suspension to support and protect the rigid tubes (C) that contain the upper cables (W). The protection (9) comprises an internal shell (90) fixed to the foot (22) of the arm of the suspension, and an external shell (91) fixed to the internal shell (90) in such a way to leave a space between the two shells (90, 91) through which the rigid tubes (C) are passed. The internal shell (90) of the protection is spaced from the lower tube (20) of the arm of the suspension, in such a way to leave a space that is suitable for passing the external tube (21) of the suspension during the travel of the telescopic arm of the suspension. Spacers (92) are disposed between the two shells (90, 91) to keep them separate. A terminal board (93) is disposed between the two shells (90, 91). The terminal board (93) is provided with holes (94) through which the rigid tubes (C) are passed. Screw means (95) are screwed in the shells (91, 90) for fixing said shells (91, 90) one to the other and to the foot (22) of the lower tube (20) of the suspension.

With reference to FIGS. 1 and 4, the guide (46) is fixed on the external tube (21) of the suspension, and is suitable for making the rigid tubes (C) with the upper cables (W) pass and slide.

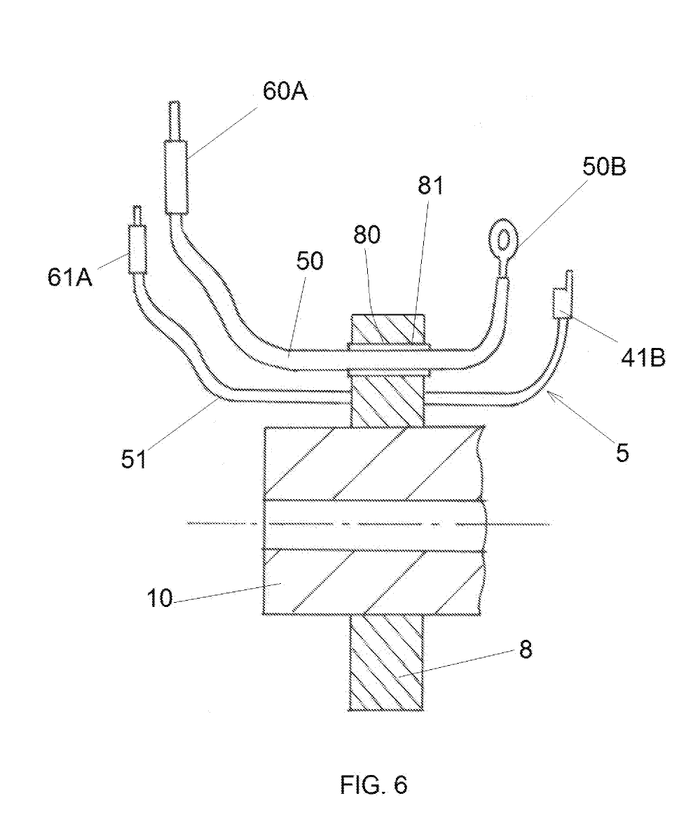

With reference to FIGS. 2 and 6, a bushing (8) is fixed to the shaft (10) of the hub assembly (1). The bushing (8) has a plurality of through peripheral holes (80) equal to the number of the external cables (5). In view of the above, the external cables (5) are passed through the through peripheral holes (80) of the bushing in order to be brought out of the hub assembly (1). Seal material (81) in liquid, paste or solid form is inserted in the through peripheral holes (80) of the bushing, in such a way to ensure the tightness of the section of the hub assembly that is crossed by the external cables (5).

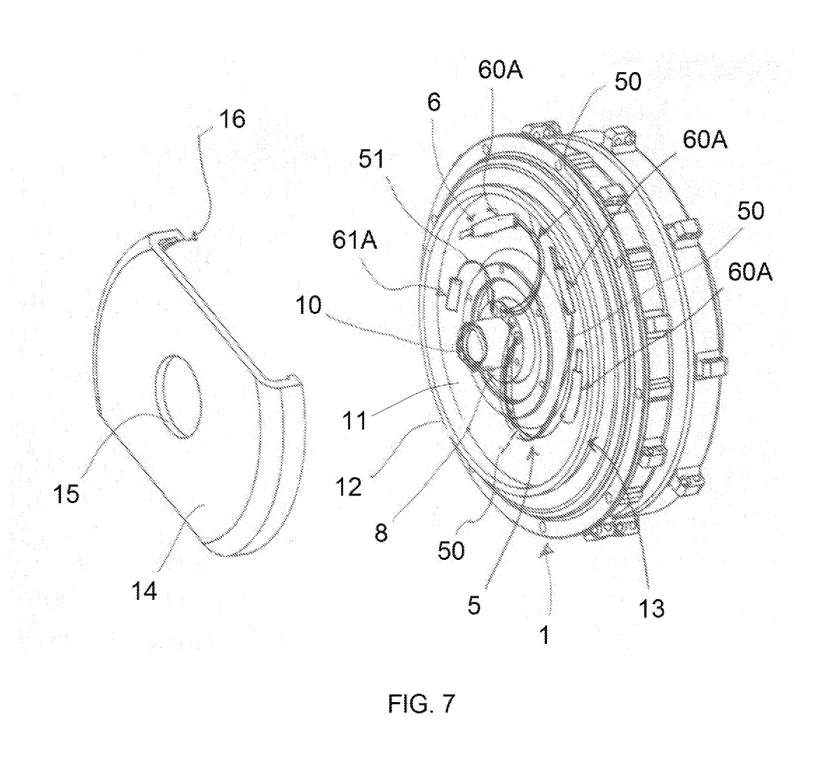

With reference to FIG. 7, the hub assembly (1) comprises a front flange (11) that covers the electric motor (M) and a peripheral collar (12) that projects frontally from the front flange (11). The peripheral collar (12) has an external groove (13).

A casing (14) is applied on the front flange (11) of the hub assembly. The casing (14) comprises an axial hole (15) crossed by the shaft (10) and teeth (16) that project inwards to be engaged in the external groove (13) of the collar of the hub assembly. In such a way, a housing is generated between the front flange (11) and the casing (14), which is suitable for containing the external cables (5). The casing (14) has smaller dimensions than the circumference defined by the collar (12) of the hub assembly, in such a way to define openings to let out the elements (60A, 61A) of the second connector assembly connected at the ends of the external cables (5).

When the wheel (R) is taken down for maintenance purposes, the elements (60A, 61A) of the second connector assembly connected at the ends of the external cables (5) are contained and protected in the space behind the casing (14), as shown in FIG. 7.

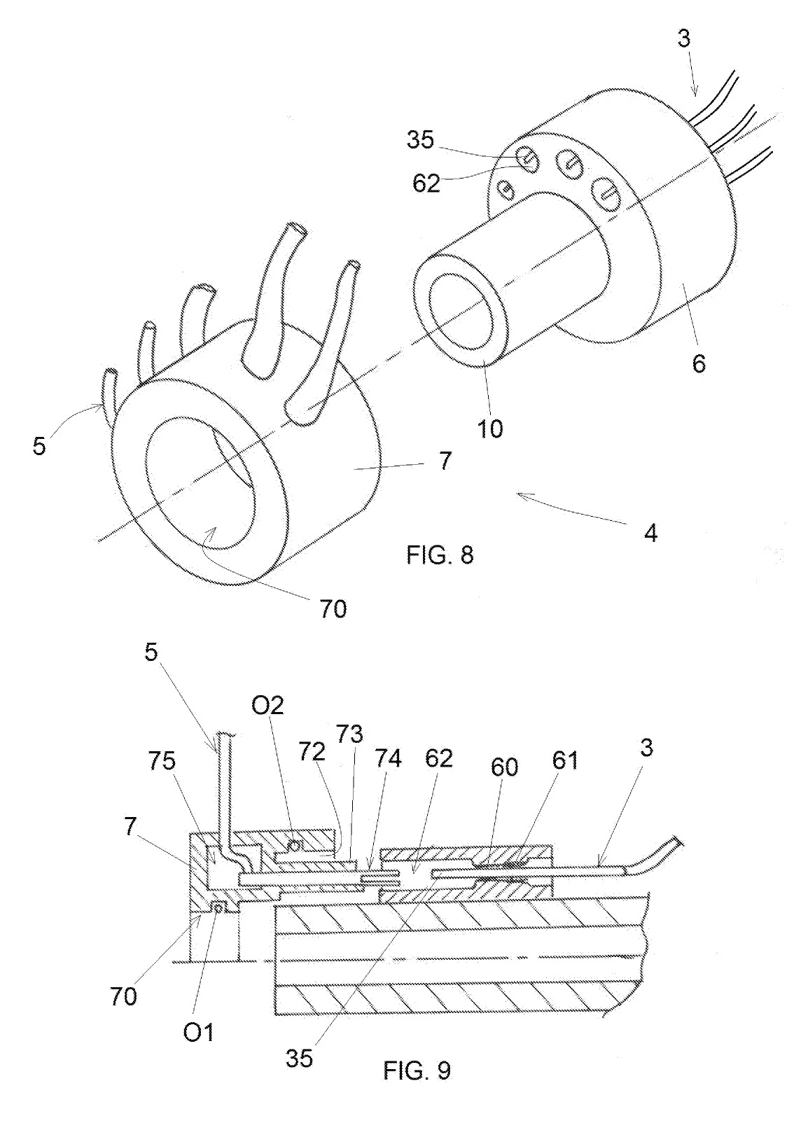

FIGS. 8 and 9 show a second embodiment of the first connector assembly (4).

In such a case, the first connector assembly (4) comprises a first 15 bushing (6) fixed to the shaft (10) of the hub assembly, and a second bushing (7) suitable for being coupled with the first bushing (6).

The first bushing (6) has a plurality of peripheral holes (60) through which the internal cables (3) connected to the electric motor are passed. Seal material (61) in liquid, paste or solid form is inserted in the peripheral holes (60) of the first bushing, in such a way to ensure the tightness of the section of the hub assembly crossed by the internal cables (3). One end (35) of each internal cable (3) is contained in a corresponding housing (62) obtained in the first bushing (6).

The second bushing (7) has an axial hole (70) that is crossed by the shaft (10) of the hub assembly. The second bushing (7) has a cylindrical housing (72) that is suitable for receiving the first bushing (6). A plurality of shanks (73) suitable for being inserted in the peripheral housings (62) of the first bushing is obtained in the cylindrical housing (72) of the second bushing. A contact (74), such as a fork contact suitable for fastening the end (35) of the internal cable that is disposed in the peripheral housing (62) of the first bushing, is disposed in each shank (73).

One end of each contact (74) is connected to a corresponding external cable (5) that passes through a housing (75) of the second bushing in order to come out radially from the lateral wall of the second bushing. OR seals (O1, O2) are respectively disposed in the axial hole (70) and in the cylindrical housing (72) of the second bushing to ensure tightness with the shaft (10) and with the first bushing (6).

Numerous equivalent variations and modifications can be made to the present embodiments of the invention, which are within the reach of an expert of the field and fall in any case within the scope of the invention.

We claim:

1. Electric motorcycle comprising:
an electric motor disposed in a hub assembly of a wheel of the motorcycle;
a suspension supporting a shaft of the hub assembly, characterized in that said electric motorcycle further comprises:
a plurality of internal cables connected to the electric motor;
a first connector assembly disposed in the hub assembly and connecting the internal cables to a plurality of external cables;
a second connector assembly disposed on the suspension and connecting the external cables to a plurality of upper cables;
a plurality of rigid tubes inside which said upper tubes are disposed, in such a way that the upper cables come out of the rigid tubes in correspondence of an upper part of the suspension;
support and guide means connected to the suspension and intended to support and guide said rigid tubes; and
an electric power system and a control unit disposed in said motorcycle and connected to said upper cables coming out of the rigid tubes.

2. The electric motorcycle of claim 1, wherein said plurality of internal cables comprises unipolar power cables and a multipolar signal cable, said plurality of external cables comprises unipolar power cables and a multipolar signal cable and said plurality of upper cables comprises unipolar power cables and a multipolar signal cable.

3. The electric motorcycle of claim 1, wherein said support and guide means comprise a protection disposed in a lower part of the suspension and a guide disposed in an upper part of the suspension.

4. The electric motorcycle of claim 3, wherein said suspension comprises a telescopic arm comprising an internal tube with a foot connected to said shaft of the hub assembly and sliding inside an external tube; said protection comprises an internal shell fixed to the foot of the internal tube of the suspension, an external shell fixed to the internal shell and a terminal board disposed between the two shells, in such manner to leave a space between the two shells through which said rigid tubes are passed, being held by the terminal board; and said guide is disposed in an upper part of the external tube of the suspension.

5. The electric motorcycle of claim 1, wherein said hub assembly comprises a bushing disposed around said shaft and provided with through peripheral holes through which said external cables are passed and taken out of the hub assembly.

6. The electric motorcycle of claim 2, wherein said first connector assembly comprises:
a power connector connecting the internal power cables to the external power cables; and
a signal connector connecting the internal signal cable to the external signal cable.

7. The electric motorcycle of claim 6, wherein said power connector is a terminal board and the ends of said internal power cables and of said external power cables are provided with ring contacts intended to be engaged in said terminal board; and said signal connector is an RJ connector comprising male and female elements.

8. The electric motorcycle of claim 2, wherein said first connector assembly comprises:
a first bushing fixed on said shaft of the hub assembly and provided with peripheral holes that receive said internal cables so that one end of the internal cables is situated in peripheral housings of the first bushing, and
a second bushing with an axial hole to receive the shaft of the hub assembly, a cylindrical housing to receive said first bushing, a plurality of shanks disposed in said cylindrical housing to be engaged in said peripheral housings of the first bushing, electric contacts disposed in said shanks and intended to come in contact with said ends of the internal cables, wherein the external cables are radially passed through said second bushing and are connected to said electric contacts.

9. The electric motorcycle of claim 2, wherein said second connector assembly comprises:
a plurality of power connectors wherein each power connector connects an external power cable to an upper power cable; and
a signal connector connecting the external signal cable to the upper signal cable.

10. The electric motorcycle of claim 9, wherein said power connectors are jack connectors comprising male and female elements; and said signal connector is a DIN connector comprising male and female elements.
